(19) United States
(12) Patent Application Publication
(10) Pub. No.: US 2025/0166926 A1
(43) Pub. Date: May 22, 2025

(54) MULTILAYER CERAMIC ELECTRONIC COMPONENT

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/036,138

(22) Filed: Jan. 24, 2025

Related U.S. Application Data
(63) Continuation of application No. PCT/JP2023/020730, filed on Jun. 4, 2023.

(30) Foreign Application Priority Data
Aug. 8, 2022 (JP) 2022-126716

(51) Int. Cl. H01G 4/30; H01G 4/012; H01G 4/12; H01G 4/232

(52) U.S. Cl. CPC H01G 4/30; H01G 4/2325; H01G 4/012; H01G 4/1227

(57) ABSTRACT

A multilayer ceramic electronic component includes a ceramic element body including first and second internal electrodes, first and second main surfaces, first and second lateral surfaces, and first and second end surfaces, and first and second external electrodes respectively on the first and second end surfaces. The first and second external electrodes each include base external electrodes, a resin layer, and at least one plated external electrode layer. The base external electrodes are discontinuously provided on the ceramic element body. The ceramic element body includes exposed regions. The resin layer covers the base external electrodes and the exposed regions. The resin layers completely cover the base external electrodes and the exposed regions on the first and second end surfaces. The first and second external electrodes include a resin layer non-formation region where the resin layer does not cover the base external electrodes or the exposed regions.

### CROSS REFERENCE TO RELATED APPLICATIONS

This application claims the benefit of priority to Japanese Patent Application No. 2022-126716 filed on Aug. 8, 2022 and is a Continuation application of PCT Application No. PCT/JP2023/020730 filed on Jun. 4, 2023. The entire contents of each application are hereby incorporated herein by reference.

### BACKGROUND OF THE INVENTION

### 1. Field of the Invention

The present invention relates to multilayer ceramic electronic components, and more particularly, to multilayer ceramic electronic components having improved mechanical strength and reliability.

### 2. Description of the Related Art

Multilayer ceramic electronic components such as multilayer ceramic capacitors, multilayer ceramic thermistors, multilayer ceramic varistors, and multilayer ceramic composite components are widely used in electronic devices. Japanese Unexamined Patent Application Publication No. 2003-243249 discloses a multilayer ceramic capacitor. FIG. 7 shows a multilayer ceramic capacitor 1100 disclosed in Japanese Unexamined Patent Application Publication No. 2003-243249.

The multilayer ceramic capacitor 1100 includes a ceramic element body 101. Internal electrodes 102 are provided inside the ceramic element body 101. External electrodes 105 are provided at both ends of the ceramic element body 101. Each of the external electrodes 105 includes a base external electrode 103 formed by firing an electrically conductive paste, and a plated layer 104 provided on the base external electrode 103.

In such a multilayer ceramic electronic component, an improvement in mechanical strength between the ceramic element body and the external electrodes is important. That is, multilayer ceramic electronic components have been demanded for which external electrodes do not peel off from a ceramic element body or cracks do not occur in the ceramic element body, even when stress is applied due to an external force, thermal cycling, or the like after being mounted on a circuit board or the like.

In such multilayer ceramic electronic components, various methods have been studied to develop methods of improving the mechanical strength between a ceramic element body and external electrodes.

Japanese Unexamined Patent Application Publication No. 2020-161734 discloses a multilayer ceramic capacitor in which the mechanical strength between a ceramic element body and external electrodes is improved by discontinuously providing underlying or base external electrodes. FIG. 8 shows a multilayer ceramic capacitor 1200 disclosed in Japanese Unexamined Patent Application Publication No. 2020-161734.

The multilayer ceramic capacitor 1200 includes a ceramic element body 201 in which ceramic layers are laminated. Internal electrodes 202 are provided between the ceramic layers of the ceramic element body 201. External electrodes 203 are provided at both ends of the ceramic element body 201.

The internal electrodes 202 are connected to the external electrodes 203 at both end surfaces of the ceramic element body 201, respectively.

Each of the external electrodes 203 includes base external electrodes 204 formed by firing an electrically conductive paste, resin layers 205, and a plated layer 206.

The base external electrodes 204 are discontinuously provided on the ceramic element body 201. The description “discontinuously provided” indicates that the coverage ratio (coverage) is not 100%. As a result, the ceramic element body 201 includes exposed regions EA which are partially exposed from the discontinuously provided base external electrodes 204. The exposed regions EA of the ceramic element body 201 are filled with the resin layers 205. The plated layer 206 is provided on the base external electrodes 204 and the resin layers 205.

In the multilayer ceramic capacitor 1200, the exposed regions EA of the ceramic element body 201 where the base external electrodes 204 are not provided are filled with the resin layers 205 in order to improve moisture resistance and reliability. In other words, the internal electrodes 202 extend toward and are exposed at a corresponding one of the end surfaces of the ceramic element body 201 in order to be connected to the external electrode 203, and it is likely for moisture to enter the inside of the ceramic element body 201 from these portions. In the multilayer ceramic capacitor 1200, since the base external electrodes 204 are discontinuously provided, if the plated layer 206 is provided on the base external electrodes 204 without providing the resin layers 205, sufficient moisture resistance cannot be obtained. Therefore, in the multilayer ceramic capacitor 1200, the exposed regions EA are filled with the resin layers 205, following which the plated layer 206 is provided on the base external electrodes 204 and the resin layers 205, thus improving the moisture resistance.

In the multilayer ceramic capacitor 1200 disclosed in Japanese Unexamined Patent Application Publication No. 2020-161734, since the base external electrodes 204 are discontinuously provided on the ceramic element body 201, the residual stress of the base external electrodes 204 provided on the ceramic element body 201 is relaxed, and the mechanical strength between the ceramic element body 201 and the external electrode 203 is increased. Therefore, in the multilayer ceramic capacitor 1200, even when stress is applied due to an external force, thermal cycling, or the like after mounting on a circuit board or the like, the external electrodes 203 (base external electrodes 204) are less likely to peel off from the ceramic element body 201, and cracks are less likely to occur in the ceramic element body 201.

However, the multilayer ceramic capacitor 1200 still has room for improvement in moisture resistance.

In each multilayer ceramic electronic component such as a multilayer ceramic capacitor, portions between the ceramic layers in the ceramic element body are exposed externally, and the surfaces at which the ends of the internal electrodes are exposed externally between the ceramic layers correspond to the surfaces from which moisture is most likely to enter. For example, in the multilayer ceramic capacitor 1200, the portions between the ceramic layers are exposed externally, and both end surfaces of the ceramic element body 201 at which the ends of the internal electrodes 202 are exposed between the ceramic layers correspond to the surfaces from which moisture is likely to enter. On the other hand, the main surfaces of the ceramic element body 201 opposed to each other in the lamination (stacking) direction are unlikely to be a path through which moisture enters because the portions between the ceramic layers are not exposed externally. Further, on both lateral surfaces of the ceramic element body 201, the portions between the ceramic layers are exposed externally. However, since the ends of the internal electrodes are not exposed externally between the ceramic layers, it is less likely for moisture to enter. On the other hand, on both end surfaces of the ceramic element body 201, the portions between the ceramic layers are exposed externally, and the ends of the internal electrodes are exposed externally between the ceramic layers, such that moisture is likely to enter the inside.

Under such circumstances, the multilayer ceramic capacitor 1200 still has room for improvement in moisture resistance. That is, when a cross section of the multilayer ceramic capacitor 1200 shown in FIG. 8 is viewed, boundary surfaces between the base external electrodes 204 and the resin layers 205 are in contact with the plated layer 206. In general, moisture is more likely to pass through the boundary surfaces between the base external electrodes 204 and the resin layers 205 than through the base external electrodes 204 and the resin layers 205. Therefore, in the multilayer ceramic capacitor 1200, moisture easily enters the ceramic element body 201 from the end surface of the ceramic element body 201 through the plated layer 206 and further through the boundary surfaces between the base external electrodes 204 and the resin layers 205.

Further, in the multilayer ceramic capacitor 1200, the resin layers 205 do not contribute to the improvement in the mechanical strength (bonding strength) between the ceramic element body 201 and the base external electrodes 204, and therefore the improvement in the mechanical strength is insufficient. That is, when the cross section of the multilayer ceramic capacitor 1200 shown in FIG. 8 is viewed, the base external electrodes 204 and the resin layers 205 are alternately and fragmentally provided in the ceramic element body 201, and therefore, the resin layers 205 do not contribute to the improvement in the mechanical strength between the ceramic element body 201 and the base external electrodes 204.

### SUMMARY OF THE INVENTION

Example embodiments of the present invention provide multilayer ceramic electronic components each with improved moisture resistance, reliability and mechanical strength between a ceramic element body and external electrodes.

An example embodiment of the present invention provides a multilayer ceramic electronic component including a ceramic element body including a plurality of first internal electrodes and a plurality of second internal electrodes laminated therein, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, a first external electrode on the first end surface and including an edge portion extending from the first end surface toward each of the first main surface, the second main surface, the first lateral surface, and the second lateral surface, and a second external electrode on the second end surface and including an edge portion extending from the second end surface toward each of the first main surface, the second main surface, the first lateral surface, and the second lateral surface. The plurality of first internal electrodes each extend toward and are exposed at the first end surface, and each are connected to the first external electrode. The plurality of second internal electrodes each extend toward and are exposed at the second end surface, and each are connected to the second external electrode. The first external electrode and the second external electrode each include base external electrodes, a resin layer provided outside the base external electrodes, and at least one plated external electrode layer provided outside the resin layer. The base external electrodes are discontinuously provided on the ceramic element body. The ceramic element body includes exposed regions partially exposed from the base external electrodes. The resin layer covers the base external electrodes and the exposed regions. In the first external electrode, the resin layer completely covers the base external electrodes and the exposed regions on the first end surface, and in the second external electrode, the resin layer completely covers the base external electrodes and the exposed regions on the second end surface. The first external electrode and the second external electrode each include, on the first main surface, the second main surface, the first lateral surface, and the second lateral surface, respectively, a region where the resin layer covers the base external electrodes and the exposed regions, and a resin layer non-formation region where the resin layer does not cover the base external electrodes or the exposed regions.

In a multilayer ceramic electronic component according to an example embodiment of the present invention, on at least the first end surface and the second end surface of the ceramic element body, the base external electrode and the exposed region of the ceramic element body are completely covered with the resin layer, and thus the moisture resistance is high and the reliability is high. That is, moisture is less likely to enter the inside, and a defective product or a failure is less likely to occur due to moisture intrusion.

Further, in a multilayer ceramic electronic component according to an example embodiment of the present invention, since the base external electrode is discontinuously provided on the ceramic element body, the residual stress of the underlying external electrode on the ceramic element body is reduced, and the mechanical strength between the ceramic element body and the external electrode is high. That is, even if a stress is applied by an external force, thermal cycling, or the like after mounting on a circuit board or the like, the external electrode is less likely to peel off from the ceramic element body, and cracks are less likely to occur in the ceramic element body.

Further, in a multilayer ceramic electronic component according to an example embodiment of the present invention, the resin layer covers the base external electrode from the outside, and contributes to an improvement in the bonding strength between the base external electrode and the ceramic element body, so that the mechanical strength between the ceramic element body and the external electrode is high. That is, even if a stress is applied by an external force, thermal cycling, or the like after mounting on a circuit board or the like, the external electrode is less likely to peel off from the ceramic element body, and cracks are less likely to occur in the ceramic element body.

Further, in a multilayer ceramic electronic component according to an example embodiment of the present invention, since the first external electrode and the second external electrode respectively have a cap shape at the end portion of the ceramic element body, the mechanical strength between the ceramic element body and the first external electrode and the second external electrode is improved.

Further, in a multilayer ceramic electronic component according to an example embodiment of the present invention, since the base external electrode and the plated external electrode layer are mechanically and electrically connected in the resin layer non-formation region, the mechanical strength of the first external electrode and the second external electrode is improved, and the electrical reliability is improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a perspective view of a multilayer ceramic capacitor 100 according to a first example embodiment of the present invention.

FIG. 1B is an exploded perspective view of a main portion of the multilayer ceramic capacitor 100.

FIG. 2 is a cross-sectional view of the multilayer ceramic capacitor 100.

FIGS. 3A and 3B are cross-sectional views showing steps performed in an example of a method of manufacturing the multilayer ceramic capacitor 100.

FIGS. 4C and 4D are subsequent to FIG. 3B, and are cross-sectional views showing steps performed in an example of a method of manufacturing the multilayer ceramic capacitor 100.

FIGS. 5E and 5F are subsequent to FIG. 4D, and are cross-sectional views showing steps performed in an example of the method of manufacturing the multilayer ceramic capacitor 100.

FIG. 6 is a cross-sectional view of a multilayer ceramic capacitor 200 according to a second example embodiment of the present invention.

FIG. 7 is a cross-sectional view illustrating a multilayer ceramic capacitor 1100 disclosed in Japanese Unexamined Patent Application, Publication No. 2003-243249.

FIG. 8 is a cross-sectional view illustrating a multilayer ceramic capacitor 1200 disclosed in Japanese Unexamined Patent Application, Publication No. 2020-161734.

### DETAILED DESCRIPTION OF THE EXAMPLE EMBODIMENTS

Hereinafter, example embodiments of the present invention will be described in detail with reference to the drawings. Each example embodiment is merely an example, and the present invention is not limited to the example embodiments. Further, it is possible to combine the contents described in different example embodiments, and such implementations are also included in the present invention. In addition, the drawings are for aiding understanding of the specification and may be schematically drawn, and the drawn components or the ratio of the dimensions between the components may not coincide with the ratio of the dimensions described in the specification. In addition, components described in the specification may be omitted in the drawings or may be drawn by omitting a number of the components.

### First Example Embodiment

In a first example embodiment of the present invention, a multilayer ceramic capacitor will be described as an example of a multilayer ceramic electronic component. However, the multilayer ceramic electronic components of example embodiments of the present invention include various types, and are not limited to the multilayer ceramic capacitor.

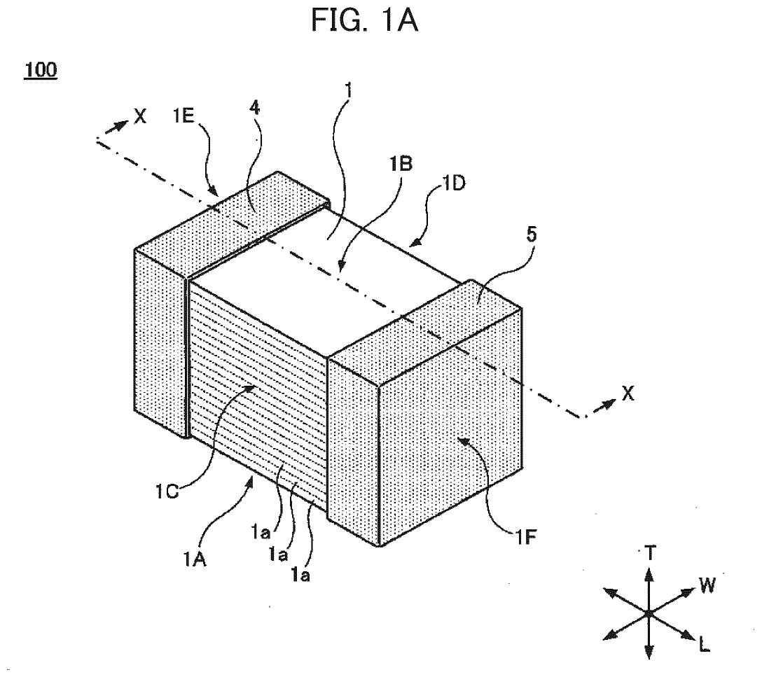

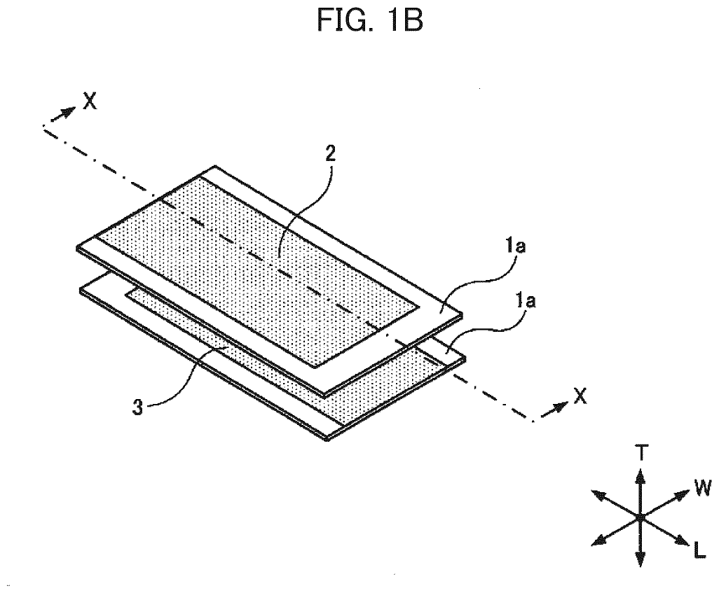

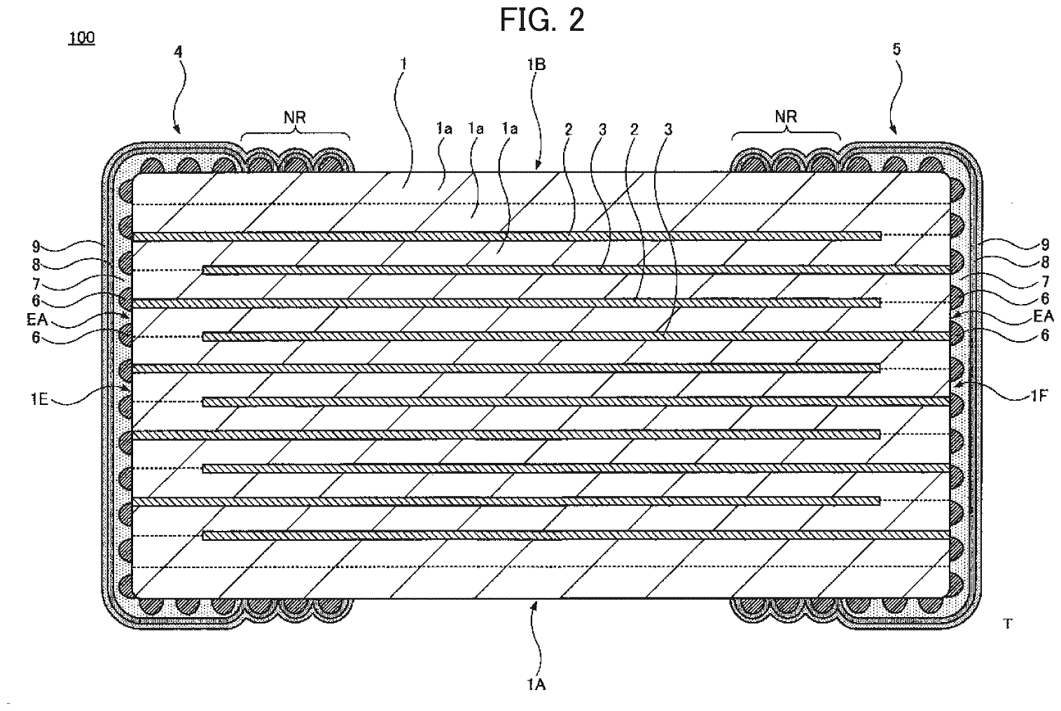

FIGS. 1A, 1B, and 2 show a multilayer ceramic capacitor 100 according to a first example embodiment. FIG. 1A is a perspective view of the multilayer ceramic capacitor 100. FIG. 1B is an exploded perspective view of a main portion of the multilayer ceramic capacitor 100, and shows two layers of a plurality of ceramic layers 1a described later. FIG. 2 is a cross-sectional view of the multilayer ceramic capacitor 100, and shows an X-X portion indicated by dashed-dotted arrows in FIGS. 1A and 1B. In addition, a height direction T, a length direction L, and a width direction W are shown in the drawings, and these directions may be referred to in the following description. In the present example embodiment, a lamination (stacking) direction of ceramic layers 1a, first internal electrodes 2, and second internal electrodes 3 described later is defined as the height direction T.

The multilayer ceramic capacitor 100 includes a ceramic element body 1 in which a plurality of ceramic layers 1a, a plurality of first internal electrodes 2, and a plurality of second internal electrodes 3 are laminated. The ceramic element body 1 has a rectangular or substantially rectangular parallelepiped shape, and includes a first main surface 1A and a second main surface 1B opposed to each other in the height direction T (lamination direction), a first lateral surface 1C and a second lateral surface 1D opposed to each other in the width direction W perpendicular or substantially perpendicular to the height direction T, and a first end surface 1E and a second end surface 1F opposed to each other in the length direction L perpendicular or substantially perpendicular to both the height direction T and the width direction W.

The dimension in the height direction T, the dimension in the width direction W, and the dimension in the length direction L of the ceramic element body 1 can be arbitrary, respectively. Unevenness may be provided on a portion or all of the first main surface 1A, the second main surface 1B, the first lateral surface 1C, the second lateral surface 1D, the first end surface 1E, and the second end surface 1F.

In the ceramic element body 1 having a rectangular or substantially rectangular parallelepiped shape, it is also preferable that ridge portions where two surfaces are in contact with each other or corner portions where three surfaces are in contact with each other are rounded. The roundness can be provided to the ridge portions or the corner portions of the ceramic element body 1 by, for example, barrel-polishing an unfired ceramic element body in a manufacturing process.

Any material can be used as the material of the ceramic element body 1 (ceramic layer 1a), and, for example, a dielectric ceramic including BaTiO₃ as a main component can be used. However, instead of BaTiO₃, for example, a dielectric ceramic mainly including other materials such as CaTiO₃, SrTiO₃, and CaZrO₃ may be used. An auxiliary component such as, for example, a Mn compound, a Fe compound, a Cr compound, a Co compound, or a Ni compound may be added to the dielectric ceramic.

The ceramic element body 1 includes any number of the laminated ceramic layers 1a. However, it is preferable to include, for example, 10 to 2000 layers including the protective layers adjacent to the first main surface 1A and the second main surface 1B where the first internal electrodes 2 or the second internal electrodes 3 are not laminated. The thickness of each of the ceramic layers 1a is preferably, for example, about 0.1 μm to about 10.0 μm.

Any material can be used as the materials of the first internal electrode 2 and the second internal electrode 3, and, for example, Ni, Cu, Ag, Pd, Au, or an alloy thereof can be used. Examples of the alloy include an Ag—Pd alloy. These metals and alloys are not limited to one type, and may include a plurality of types.

The first internal electrode 2 and the second internal electrode 3 can have any shape in the planar direction, but may be rectangular or substantially rectangular, for example. In the planar shapes of the first internal electrode 2 and the second internal electrode 3, the corners may be rounded or the sides may be tapered.

The number of layers of the first internal electrode 2 and the second internal electrode 3 is arbitrary, but it is preferably, for example, 10 to 2000 layers. The thickness of each of the first internal electrode 2 and the second internal electrode 3 is arbitrary, but is preferably about 0.1 μm to about 10.0 μm, for example.

The first internal electrodes 2 and the second internal electrodes 3 are preferably alternately laminated in the ceramic element body 1. When the ceramic element body 1 is viewed in the height direction T, the first internal electrodes 2 and the second internal electrodes 3 overlap each other. Capacitance is generated between each of the first internal electrodes 2 and each of the second internal electrodes 3 overlapping each other with a corresponding one of the ceramic layers 1a interposed therebetween, such that the characteristics of a capacitor are provided.

Each of the first internal electrodes 2 extends toward and are exposed at a first end surface 1E of the ceramic element body 1. Each of the second internal electrodes 3 extend toward and are exposed at the second end surface 1F of the ceramic element body 1. Neither the first internal electrodes 2 nor the second internal electrodes 3 are exposed at the first lateral surface 1C or the second lateral surface 1D of the ceramic element body 1. That is, gaps are provided between each of the first internal electrodes 2 and each of the second internal electrodes 3, and both surfaces of the first lateral surface 1C and the second lateral surface 1D.

A first external electrode 4 is provided at one end of the ceramic element body 1. A second external electrode 5 is provided on the other end of the ceramic element body 1. Each of the first external electrode 4 and the second external electrode 5 has a cap shape. That is, the first external electrode 4 is provided on the first end surface 1E of the ceramic element body 1, and further, the edge portion thereof extends from the first end surface 1E toward the first main surface 1A, the second main surface 1B, the first lateral surface 1C, and the second lateral surface 1D. The second external electrode 5 is provided on the second end surface 1F of the ceramic element body 1, and further, the edge portion thereof extends from the second end surface 1F toward the first main surface 1A, the second main surface 1B, the first lateral surface 1C, and the second lateral surface 1D.

However, the first external electrode 4 may be provided at least on the first end surface 1E of the ceramic element body 1, and may not be provided on the first main surface 1A, the second main surface 1B, the first lateral surface 1C, or the second lateral surface 1D. The second external electrode 5 may be provided at least on the first end surface 1E of the ceramic element body 1, and may not be provided on the first main surface 1A, the second main surface 1B, the first lateral surface 1C, or the second lateral surface 1D.

The thickness of each of the first external electrode 4 and the second external electrode 5 is arbitrary, but is preferably about 0.1 μm to about 20.0 μm, for example.

The plurality of first internal electrodes 2 are electrically connected to the first external electrode 4. The plurality of second internal electrodes 3 are electrically connected to the second external electrode 5.

As shown in FIG. 2, each of the first external electrode 4 and the second external electrode 5 includes base external electrodes 6 provided on the outer surface of the ceramic element body 1, a resin layer 7 provided on the base external electrode 6, and at least one plated external electrode layer provided on the resin layer 7.

The resin layer 7 of the present example embodiment includes a metal. The material of the resin layer 7 may be referred to as an electrically conductive resin. However, when electrical connection between the base external electrodes 6 and the plated external electrode layer is possible, it is also possible to use a material that does not include a metal for the material of the resin layer 7.

In the present example embodiment, each of the first external electrode 4 and the second external electrode 5 includes, for example, a first Ni plated electrode layer 8 and a second Sn plated electrode layer 9 as plated external electrode layers.

In the present example embodiment, each of the first external electrode 4 and the second external electrode 5 includes a resin layer non-formation region NR in which the resin layer 7 does not cover the base external electrodes 6. In the resin layer non-formation region NR, the plated external electrode layer (first Ni plated electrode layer 8) covers the base external electrodes 6, and both are mechanically and electrically connected.

Any material can be used for the material of the base external electrodes 6, and the material includes, for example, a metal and a glass component. The base external electrodes 6 may be formed by co-firing with the ceramic element body 1, or may be formed by applying an electrically conductive paste to the ceramic element body 1 and firing the paste.

Any kind of metal included in the base external electrode 6 can be used, and, for example, Cu, Ni, Ag, Pd, Au, or an alloy thereof can be used. Examples of the alloy include an Ag—Pd alloy. These metals and alloys are not limited to one type, and may include a plurality of types.

Any type of the glass component included in the base external electrodes 6 can also be used, and, for example, one including at least one of B, Si, Ba, Mg, Al, Li, or the like can be used.

The base external electrodes 6 are not limited to a single layer, and may include a plurality of layers. Although the thickness of each of the base external electrodes 6 is arbitrary, for example, it is preferable that the dimension of the first external electrode 4 in the vicinity of the middle of the first end surface 1E and the dimension of the second external electrode 5 in the vicinity of the middle of the second end surface 1F are each about 20 μm or less.

As can be seen from FIG. 2, the base external electrodes 6 are discontinuously provided on the ceramic element body 1. The description “discontinuously provided” indicates that the coverage is not 100%. As a result, the ceramic element body 1 includes the exposed regions EA partially exposed from the discontinuously provided base external electrodes 6. When the coverage of the base external electrodes 6 is high, the exposed regions EA each tend to appear in an island shape in the base external electrodes 6. Conversely, when the coverage of the base external electrodes 6 is low, the base external electrodes 6 each tend to appear in an island shape in the exposed regions EA. The exposed regions EA may be uniformly provided over the entire base external electrodes 6, or may be provided intensively in a portion of the base external electrodes 6.

When the exposed regions EA are uniformly provided over the entire base external electrodes 6, the thicknesses of the base external electrodes 6 can be made uniform (even) over the entire base external electrodes 6, and a portion protruding excessively and having a larger thickness is not provided, such that it is possible to reduce or prevent an increase in the external dimensions of the multilayer ceramic capacitor 100 including the first external electrode 4 and the second external electrode 5.

In the first external electrode 4 and the second external electrode 5, when the exposed regions EA are concentrated more in the peripheral regions of the first end surface 1E and the second end surface 1F than in the central regions of the first end surface 1E and the second end surface 1F, the thicknesses of the base external electrode 6 in the central regions of the first end surface 1E and the second end surface 1F can be made larger than the thicknesses of the base external electrode 6 in the peripheral regions of the first end surface 1E and the second end surface 1F, such that it is possible to improve the adhesion strength between the ceramic element body 1 and the base external electrodes 6.

For example, it is preferable that the average dimension of the exposed regions EA (average dimension of the portions between the base external electrodes 6 adjacent to each other) appearing in the cross section of the multilayer ceramic capacitor 100 parallel or substantially parallel to the first lateral surface 1C and the second lateral surface 1D is about 0.1 μm or more and about 10.0 μm or less. This is because, when the thickness is less than about 0.1 μm, necking may occur between the base external electrodes 6, the residual stress of the base external electrodes 6 may increase, and the mechanical strength (bonding strength) between the ceramic element body 1 and the base external electrodes 6 may decrease. This is also because, when the thickness exceeds about 10.0 μm, the electrical connectivity between the first internal electrode 2 and the first external electrode 4 and between the second internal electrode 3 and the second external electrode 5 decreases, which may lead to a decrease in the capacitance of the multilayer ceramic capacitor 100 and an increase in the equivalent series resistance (ESR).

The thickness of the base external electrode 6 is arbitrary, but it is preferable that the maximum thickness at the first end surface 1E and the second end surface 1F is about 20 μm or less, for example.

In the multilayer ceramic capacitor 100, the resin layer 7 covers the base external electrodes 6 and the exposed regions EA. The resin layer 7 completely covers the base external electrodes 6 and the exposed regions EA at least on the first end surface 1E of the ceramic element body 1. Further, the resin layer 7 completely covers the base external electrodes 6 and the exposed regions EA at least on the second end surface 1F of the ceramic element body 1. The description “completely cover” indicates that the base external electrodes 6 and the exposed regions EA are completely hidden by the resin layer 7, and the base external electrodes 6 and the exposed regions EA (ceramic element body 1) are not exposed to the outside.

The reason why the resin layer 7 completely covers the base external electrodes 6 and the exposed regions EA at least on the first end surface 1E and the second end surface 1F of the ceramic element body 1 is as follows. That is, when the resin layer 7 does not completely cover the base external electrodes 6 and the exposed regions EA, the base external electrodes 6 and the resin layer 7 are alternately and fragmentally provided in the height direction T on the first end surface 1E and the second end surface 1F of the ceramic element body 1 in a cross section parallel or substantially parallel to the first lateral surface 1C and the second lateral surface 1D. However, in this configuration, the resin layer 7 does not contribute to the improvement in the bonding strength, the compressive stress in the height direction T of the first external electrode 4 and the second external electrode 5 becomes weak, and the bonding strength of the first external electrode 4 and the second external electrode 5 with respect to the ceramic element body 1 becomes insufficient. That is, it is likely for the first external electrode 4 and the second external electrode 5 to easily peel off from the ceramic element body 1. In contrast, in the multilayer ceramic capacitor 100, the resin layer 7 completely covers the base external electrodes 6 and the exposed regions EA at least on the first end surface 1E and the second end surface 1F of the ceramic element body 1. Therefore, the compressive stress in the height direction T of the first external electrode 4 and the second external electrode 5 is strong, the bonding strength of the first external electrode 4 and the second external electrode 5 with respect to the ceramic element body 1 is improved, and the first external electrode 4 and the second external electrode 5 are less likely to peel off from the ceramic element body 1.

In addition, when the resin layer 7 completely covers the base external electrodes 6 and the exposed regions EA at least on the first end surface 1E and the second end surface 1F of the ceramic element body 1, the resin layer 7 protects the base external electrodes 6 provided on the ceramic element body 1, and the base external electrodes 6 are less likely to peel off from the ceramic element body 1, such that the bonding strength of the first external electrode 4 and the second external electrode 5 with respect to the ceramic element body 1 is improved.

In addition, in the multilayer ceramic capacitor 100, the moisture resistance is improved by the resin layer 7 completely covering the base external electrodes 6 and the exposed regions EA on the first end surface 1E and the second end surface 1F of the ceramic element body 1. That is, as described above, although the first end surface 1E and the second end surface 1F of the ceramic element body 1 are paths through which moisture is likely to enter the ceramic element body 1, the moisture resistance is improved because these portions are completely covered with the resin layer 7.

Therefore, the multilayer ceramic capacitor 100 has high reliability.

The surface of the resin layer 7 provided on the first end surface 1E and the second end surface 1F of the ceramic element body 1 may be flat or may be uneven.

On the other hand, the portions of the first external electrode 4 provided on the first main surface 1A, the second main surface 1B, the first lateral surface 1C, and the second lateral surface 1D of the ceramic element body 1 each include the region in which the resin layer 7 covers the base external electrodes 6 and the exposed regions EA, and the resin layer non-formation region NR in which the resin layer 7 does not cover the base external electrodes 6 and the exposed regions EA at all. Similarly, the portions of the second external electrode 5 provided on the first main surface 1A, the second main surface 1B, the first lateral surface 1C, and the second lateral surface 1D of the ceramic element body 1 each include the region in which the resin layer 7 covers the base external electrodes 6 and the exposed regions EA, and the resin layer non-formation region NR in which the resin layer 7 does not cover the base external electrodes 6 and the exposed regions EA at all.

The resin layer non-formation region NR of the first external electrode 4 is spaced away from the first end surface 1E of the ceramic element body 1. The resin layer non-formation region NR of the second external electrode 5 is spaced away from the second end surface 1F of the ceramic element body 1. In the resin layer non-formation region NR, since the end portions of the base external electrodes 6 and the plated external electrode layer (for example, the Ni plated electrode layer 8 and the Sn plated electrode layer 9) are directly bonded to each other, the first external electrode 4 and the second external electrode 5 are strengthened, and the mechanical strength is improved. Further, in the resin layer non-formation region NR, the base external electrodes 6 and the plated external electrode layer are electrically connected to each other.

In the portions of the first external electrode 4 and the second external electrode 5 provided on the first main surface 1A, the second main surface 1B, the first lateral surface 1C, and the second lateral surface 1D of the ceramic element body 1, the dimension in the length direction L of the region where the resin layer 7 covers the base external electrodes 6 and the exposed regions EA is, for example, preferably about 75% or less when the dimension in the length direction L of the first external electrode 4 is defined as 100%. In this case, it is possible to ensure a sufficiently large dimension in the length direction L of the resin layer non-formation region NR, it is possible to increase the bonding strength between the end portions of the base external electrodes 6 and the plated external electrode layer, and it is possible to improve the mechanical strength of the first external electrode 4 and the second external electrode 5.

As described above, in the present example embodiment, the resin layer 7 includes a metal. Therefore, the first external electrode 4 and the second external electrode 5 are electrically connected to the base external electrodes 6 and the plated external electrode layers (for example, the Ni plated electrode layer 8 and the Sn plated electrode layer 9) via the resin layer 7. The thickness of the resin layer 7 is preferably, for example, about 0.1 μm or more and about 100 μm or less in the portions of the ceramic element body 1 in the vicinity of the middle of the first end surface 1E and the second end surface 1F where the base external electrodes 6 are not provided. Further, the thickness of the resin layer 7 is preferably, for example, about 0.1 μm or more and about 100 μm or less in the vicinity of the middle in the length direction L of the first external electrode 4 and the second external electrode 5 on the first main surface 1A, the second main surface 1B, the first lateral surface 1C, and the second lateral surface 1D of the ceramic element body 1.

The resin layer 7 includes, for example, a thermosetting resin and a metal. Since the resin layer 7 includes a thermosetting resin, it is generally more flexible than the base external electrodes 6 and the plated external electrode layer (for example, the Ni plated electrode layer 8 and the Sn plated electrode layer 9). For this reason, even when a physical impact or shock due to thermal cycling is applied to the multilayer ceramic capacitor 100, the resin layer 7 functions as a buffer layer, and thus the occurrence of cracks in the ceramic element body 1 is reduced or prevented.

As the resin included in the resin layer 7, for example, various known thermosetting resins such as an epoxy resin, a phenol resin, a urethane resin, a silicone resin, or a polyimide resin can be used. Among them, an epoxy resin is one of the most suitable resins because it has excellent heat resistance, moisture resistance, adhesion, and the like.

The resin included in the resin layer 7 is preferably, for example, about 25% by volume or more and about 65% by volume or less with respect to the total volume of the material of the resin layer 7.

The resin layer 7 preferably includes a curing agent together with a thermosetting resin. When an epoxy resin is used as the base resin, various known compounds of, for example, a phenol system, amine system, acid anhydride system, imidazole system or the like can be used as the curing agent.

As the metal included in the resin layer 7, for example, a metal filler of Ag, Cu, Ni, or an alloy thereof can be used.

The surfaces of these metal fillers may be coated with, for example, Ag or the like. When the surface of the metal filler is coated with Ag, for example, it is preferable that Cu, Ni, or the like is used for the main body of the metal filler. Alternatively, for example, a Cu metal filler subjected to an oxidation preventing treatment may be used.

When Ag is used as the metal filler included in the resin layer 7, since Ag is a metal having an extremely low specific resistance among metals, and Ag does not oxidize and has high weatherability, it is possible to provide a favorable resin layer 7. Further, when a metal other than Ag is used as the metal included in the resin layer 7 and Ag is coated on the surface, the resin layer 7 can be manufactured at low cost while maintaining the favorable characteristics of Ag.

The metal included in the resin layer 7 is preferably, for example, about 35 vol % or more and about 75 vol % or less with respect to the total volume of the material of the resin layer 7.

The shape of the metal included in the resin layer 7 is not particularly limited. For example, it may be spherical, flat, or the like. It is also preferable to use a mixture of a spherical shape and a flat shape. The average particle diameter of the metal included in the resin layer 7 is not particularly limited. The average particle diameter of the metal included in the resin layer 7 may be, for example, about 0.3 μm or more and about 10 μm or less.

The metal included in the resin layer 7 is responsible for ensuring electrical conductivity in the resin layer 7. That is, when the metal fillers are in contact with each other, an electrical conduction path is generated inside the resin layer 7.

In the present example embodiment, as plated external electrode layers, for example, the first Ni plated electrode layer 8 and the second Sn plated electrode layer 9 are provided on the first external electrode 4 and the second external electrode 5. However, the number and materials of the plated electrode layers are arbitrary and can be changed. As materials of the plated electrode layer, for example, Cu, Ag, Pd, Au, an Ag—Pd alloy, or the like can be used in addition to Ni and Sn. For example, instead of the two-layer configuration of the Ni plated electrode layer 8 of the first layer and the Sn plated electrode layer 9 of the second layer, a three-layer configuration may be used in which the Sn plated electrode layer is used as the first layer, the Ni plated electrode layer is used as the second layer, and the Sn plated electrode layer is used as the third layer.

The thickness of the plated external electrode layer per layer is preferably, for example, about 0.1 μm or more and about 20.0 μm or less.

The first Ni plated electrode layer 8 covers the resin layer 7 in the region where the resin layer 7 is provided, and covers the base external electrodes 6 and the ceramic element body 1 in the resin layer non-formation region NR where the resin layer 7 is not provided. When the Ni plated electrode layer 8 covers the resin layer 7, the Ni plated electrode layer 8 preferably completely covers the resin layer 7. The Ni plated electrode layer 8 prevents the base external electrodes 6 from being eroded by solder when the multilayer ceramic capacitor 100 is mounted.

The second Sn plated electrode layer 9 covers the Ni plated electrode layer 8. The Sn-plated electrode layer 9 improves wettability of solder when the multilayer ceramic capacitor 100 is mounted.

In the multilayer ceramic capacitor 100 according to the first example embodiment having the above-described configuration, since the base external electrodes 6 are discontinuously provided on the ceramic element body 1, the residual stress of the base external electrodes 6 provided on the ceramic element body 1 is relaxed, and the mechanical strength between the ceramic element body 1 and the first external electrode 4 and the second external electrode 5 is high.

Further, in the multilayer ceramic capacitor 100 according to the present example embodiment, since the base external electrodes 6 and the exposed regions EA of the ceramic element body 1 are completely covered with the resin layer 7 at least on the first end surface 1E and the second end surface 1F of the ceramic element body 1, the moisture resistance is high and the reliability is high.

### Example of Method of Manufacturing Multilayer Ceramic Capacitor 100

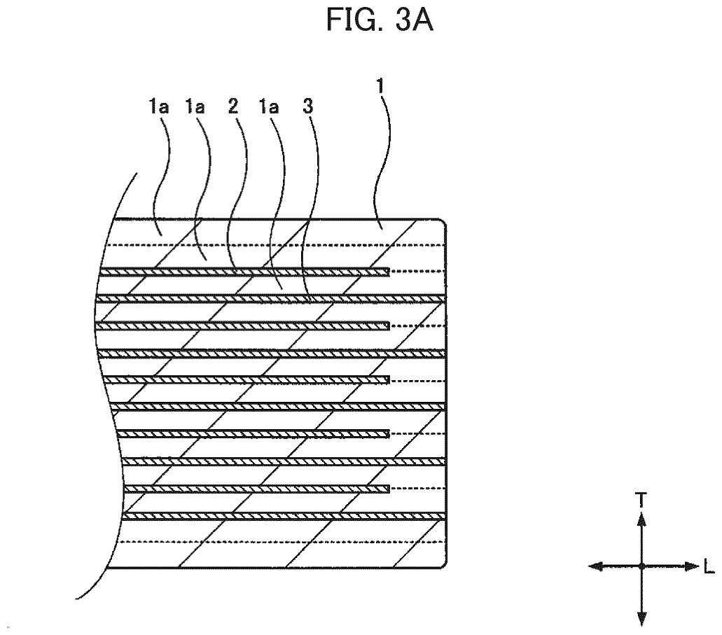

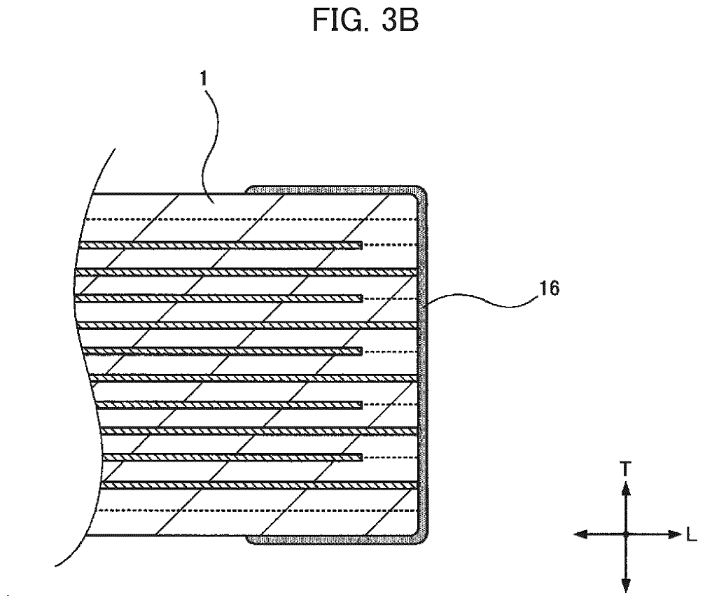

An example of a method of manufacturing the multilayer ceramic capacitor 100 will be described with reference to FIGS. 3A to 5F.

First, the ceramic element body 1 shown in FIG. 3A is manufactured.

Although not shown, first, powder of a dielectric ceramic, a binder resin, a solvent, and the like are prepared and wet-mixed to prepare a ceramic slurry.

Next, the ceramic slurry is applied onto the carrier film in a sheet shape using, for example, a die coater, a gravure coater, a microgravure coater, or the like, and dried to prepare a ceramic green sheet.

Next, in order to form the first internal electrode 2 and the second internal electrode 3, an electrically conductive paste prepared in advance is printed in a desired pattern shape on the main surface of a predetermined ceramic green sheet. In addition, the electrically conductive paste is not printed on the ceramic green sheet functioning as the protective layer.

Next, green are ceramic sheets laminated in predetermined order and integrated by, for example, isostatic pressing or the like to produce an unfired ceramic element body block.

Next, the unfired ceramic element body block is cut into a predetermined size to obtain individual unfired ceramic element bodies.

Next, if necessary, the unfired ceramic element body is subjected to barrel polishing to round ridge portions and corner portions.

Next, the unfired ceramic element body is fired in a predetermined profile to complete the ceramic element body 1. For example, the firing temperature is about 900° C. to about 1400° C. At this time, the electrically conductive paste printed on the main surface of the ceramic green sheet is also fired at the same time, and the first internal electrode 2 and the second internal electrode 3 are formed inside the ceramic element body 1.

Next, in order to form the base external electrodes 6 on the ceramic element body 1, as shown in FIG. 3B, an electrically conductive paste 16 is applied to both end portions of the ceramic element body 1. Specifically, for example, the end portions of the ceramic element body 1 are each dipped in a bath including the electrically conductive paste 16. By adjusting the number of times and depth of dipping, it is possible to adjust the formation position, amount, shape, and the like of the electrically conductive paste 16 to be applied.

In the present example embodiment, the thickness of the electrically conductive paste 16 to be applied to the end portions of the ceramic element body 1 is made smaller than that in a case of manufacturing general multilayer ceramic capacitors. This is because the base external electrodes 6 are discontinuously provided on the ceramic element body 1.

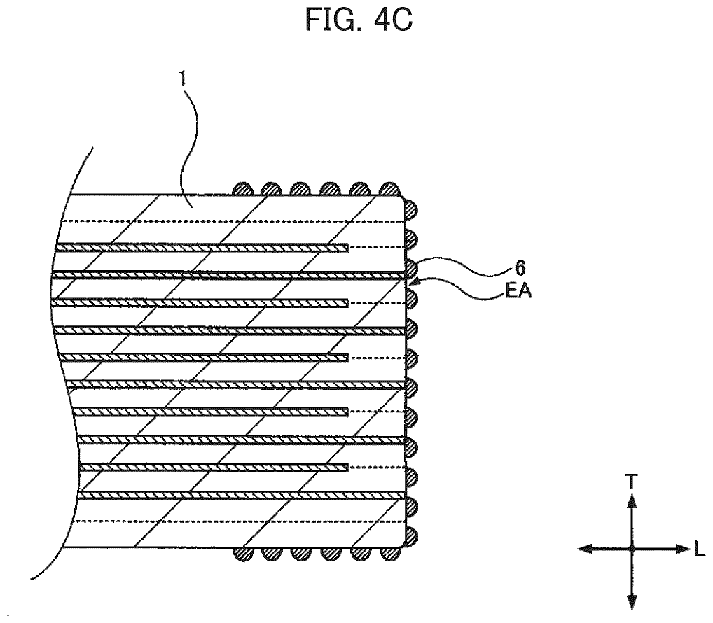

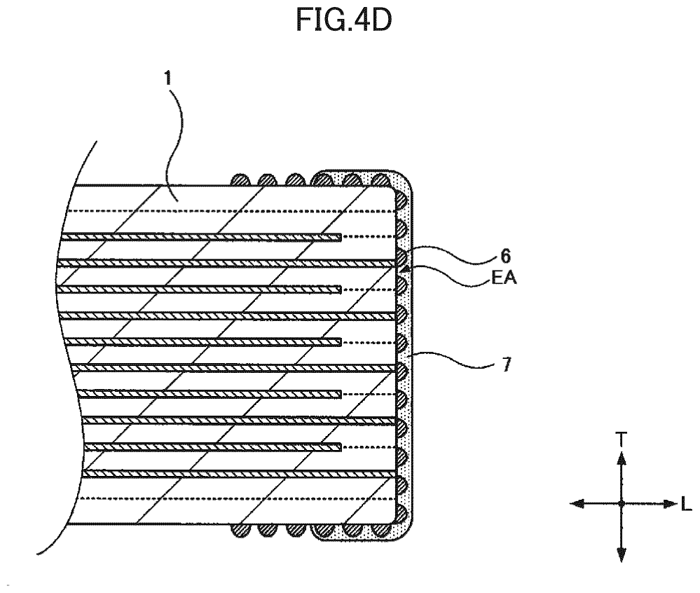

Next, the ceramic element body 1 is heated in a predetermined profile, and the electrically conductive paste 16 applied to the end portions of the ceramic element body 1 is fired on the ceramic element body 1. The firing temperature is, for example, about 700° C. to about 900° C. As a result, as shown in FIG. 4C, the discontinuously provided base external electrodes 6 are formed at both ends of the ceramic element body 1. The ceramic element body 1 includes the exposed regions EA partially exposed from the base external electrodes 6.

Next, as shown in FIG. 4D, the resin layer 7 is formed on the ceramic element body 1 on which the base external electrodes 6 are formed.

Specifically, first, a resin paste including a thermosetting resin and a metal component is applied onto the firing layer. The application of the paste is performed, for example, by dipping the end portions of the ceramic element body 1 in a bath filled with a resin paste.

Next, heat treatment is performed at a desired temperature to thermally cure the thermosetting resin, thus forming a resin layer. The temperature of the heat treatment is, for example, about 250° C. or higher and about 550° C. or lower, but may be higher. The atmosphere during the heat treatment is preferably, for example, an N₂ atmosphere. Further, in order to prevent scattering of the resin and oxidation of various metal components, the oxygen concentration is preferably, for example, about 100 ppm or less.

The dimension and shape in the length direction L of the base external electrodes 6 formed on the first main surface 1A, the second main surface 1B, the first lateral surface 1C, the second lateral surface 1D, the first end surface 1E, and the second end surface 1F of the ceramic element body 1 can be adjusted by changing the clearance of the pressing amount or the paste amount when applying the resin paste by dipping.

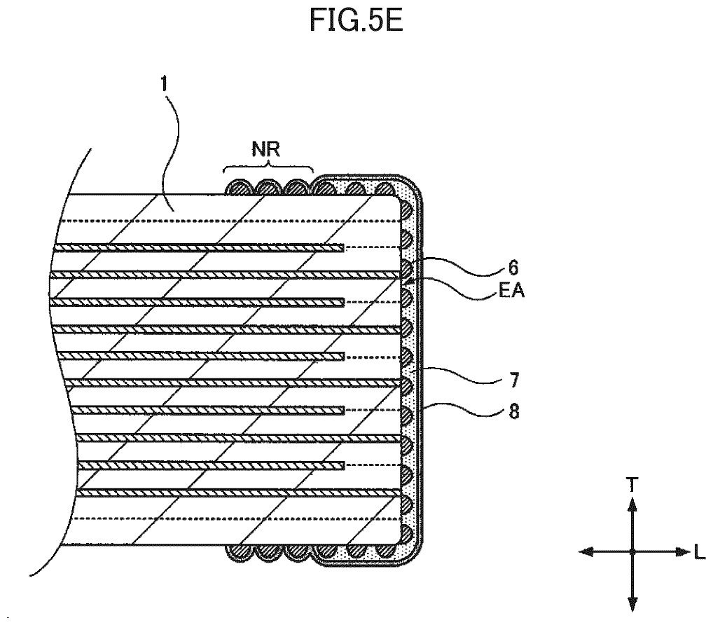

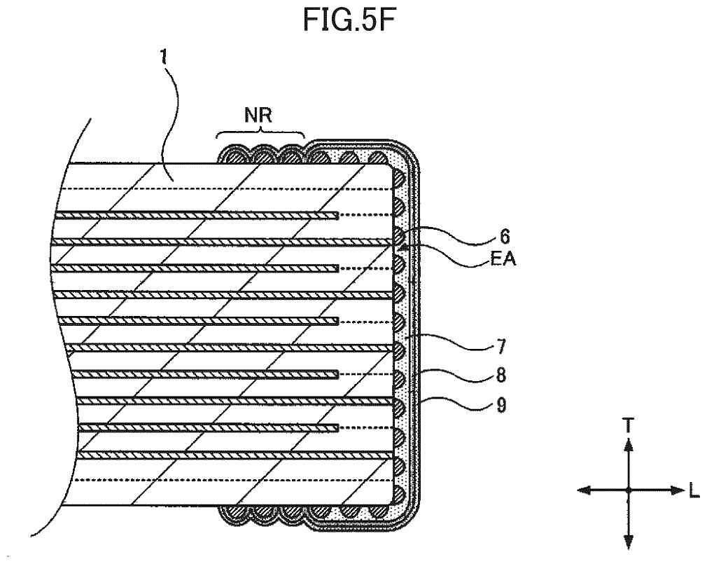

Next, as shown in FIG. 5E, the Ni plated electrode layer 8 is formed on the surface of the resin layer 7 in the region where the resin layer 7 is formed, and is formed on the surfaces of the base external electrodes 6 and the ceramic element body 1 in the resin layer non-formation region NR where the resin layer 7 is not formed. The formation method of the Ni plated electrode layer 8 is arbitrary. However, for example, electrolytic barrel plating can be used.

Next, as shown in FIG. 5F, the Sn plated electrode layer 9 is formed on the surface of the Ni plated electrode layer 8, thus completing the multilayer ceramic capacitor 100. The formation method of the Sn plated electrode layer 9 is arbitrary. However, for example, electrolytic barrel plating can be used.

### Modification of First Example Embodiment

A portion of the configuration of the multilayer ceramic capacitor 100 according to the first example embodiment is changed to manufacture a multilayer ceramic capacitor according to a modification of the first example embodiment.

The basic configuration of the multilayer ceramic capacitor according to the present modification is the same or substantially same as the configuration of the multilayer ceramic capacitor 100 according to the first example embodiment shown in FIG. 2. Therefore, FIG. 2 is referred to in the following description. However, the resin layer 7 of the multilayer ceramic capacitor shown in FIG. 2 is replaced with a resin layer 7′.

As described above, in the multilayer ceramic capacitor 100 according to the first example embodiment, the resin layer 7 includes metal. On the other hand, the multilayer ceramic capacitor according to the modification is modified so that the resin layer 7′ does not include metal.

In the multilayer ceramic capacitor according to the present modification, the resin layer 7′ does not have electric conductivity. Therefore, in the multilayer ceramic capacitor according to the present modification, the base external electrodes 6 and the plated external electrode layer are electrically connected to each other in the resin layer non-formation region NR in which the plated external electrode layer (for example, the Ni plated electrode layer 8, the Sn plated electrode layer) is provided on the base external electrodes 6. Other configurations of the multilayer ceramic capacitor according to the modification are the same or substantially same as those of the multilayer ceramic capacitor 100.

### Second Example Embodiment

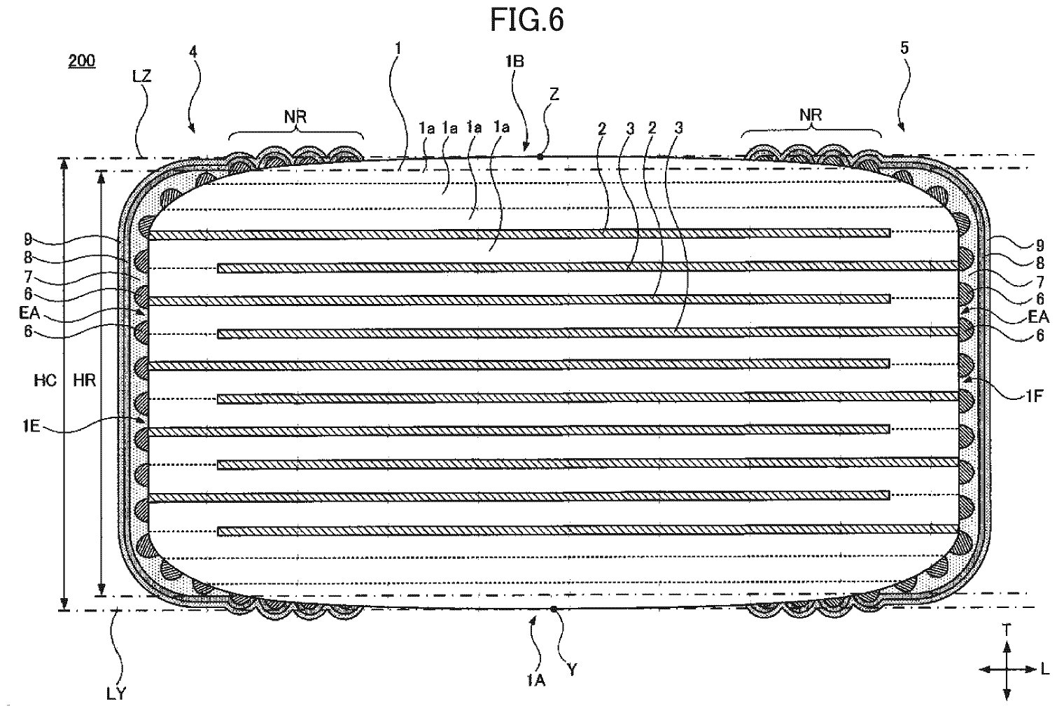

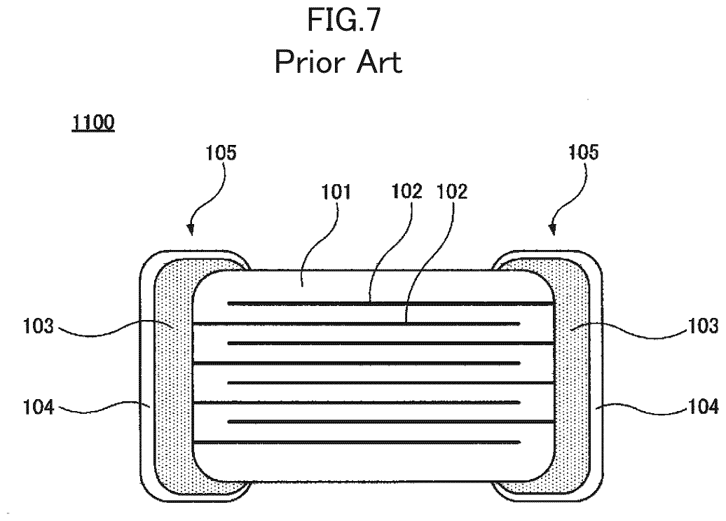

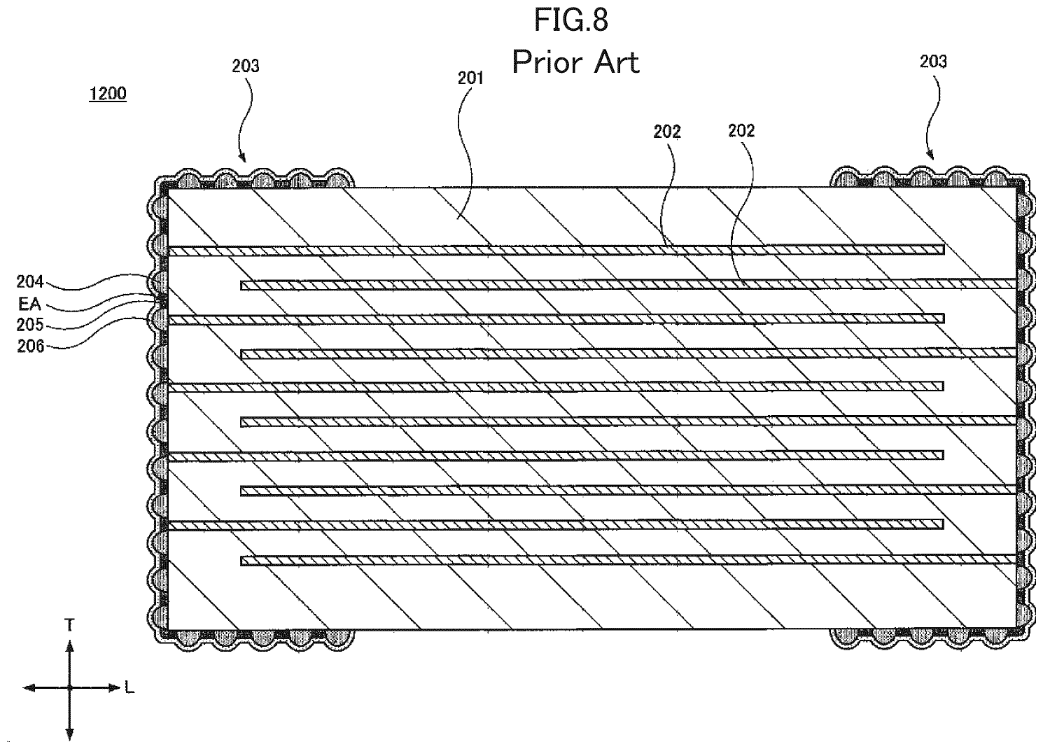

FIG. 6 shows a multilayer ceramic capacitor 200 according to a second example embodiment of the present invention. FIG. 6 is a cross-sectional view of the multilayer ceramic capacitor 200 parallel or substantially parallel to the first lateral surface 1C and the second lateral surface 1D.

In the multilayer ceramic capacitor 200 according to the second example embodiment, in a cross section parallel or substantially parallel to the first lateral surface 1C and the second lateral surface 1D shown in FIG. 6, when a portion where the dimension in the height direction T of the ceramic element body 1 becomes the largest is obtained, a first point Y on the first main surface 1A, which is one starting point of the dimension, and a second point Z on the second main surface 1B, which is the other starting point of the dimension, are obtained, and when a first imaginary line LY passing through the first point Y extending in the length direction L and a second imaginary line LZ passing through the second point Z extending in the length direction L are drawn, the first imaginary line LY neither overlaps with the resin layer 7 of the first external electrode 4 nor the resin layer 7 of the second external electrode 5, and the second imaginary line LZ neither overlaps with the resin layer 7 of the first external electrode 4 nor the resin layer 7 of the second external electrode 5. In addition, each of the first point Y and the second point z may exist at a plurality of positions. In other words, the maximum dimension HC in the height direction T of the ceramic element body 1 is larger than the maximum dimension HR in the height direction T of the resin layer 7 in the first external electrode 4 and the second external electrode 5.

Since the multilayer ceramic capacitor 200 according to the second example embodiment includes the above-described configuration, when the multilayer ceramic capacitor is mounted on a substrate or the like by, for example, reflow soldering or the like, an opposite surface that connects a plurality of protruding portions appearing on the surface of the Ni plated electrode layer 8 and is opposed to the mounting surface (upper main surface) of the substrate enters a more parallel state relative to the mounting surface of the substrate. Therefore, the multilayer ceramic capacitor 200 can be stably mounted on a substrate or the like, and mounting defects such as the tombstone phenomenon, for example, are less likely to occur. In addition, the Sn plated electrode layer 9 generally disappears by reflow soldering.

The above-described configurations of the first external electrode 4 and the second external electrode 5 of the multilayer ceramic capacitor 200 can be formed by, for example, a method in which barrel polishing is applied to an unfired ceramic element body in a manufacturing process so that the ridge line portions and the corner portions of the ceramic element body 1 have slightly large rounding shapes.

Example embodiments of the present invention have been described above. However, the present invention is not limited to the above-described configurations, and various modifications can be made in accordance with the spirit of the present invention.

For example, although the multilayer ceramic capacitor 100 has been described as an example in the above example embodiments, the present invention includes any type of the multilayer ceramic electronic components, and thus, example embodiments of the present invention are not limited to the multilayer ceramic capacitor. The present invention can be applied to all kinds of multilayer ceramic electronic components such as, for example, multilayer ceramic thermistors, multilayer ceramic varistors, multilayer ceramic inductors, and multilayer ceramic composite components.

In the above example embodiments, the resin layer non-formation region NR is provided in each of the first external electrode 4 and the second external electrode 5, but the resin layer non-formation region NR may be omitted.

In the above example embodiments, the first external electrode 4 and the second external electrode 5 are provided on the first main surface 1A, the second main surface 1B, the first lateral surface 1C, the second lateral surface 1D, the first end surface 1E, and the second end surface 1F of the ceramic element body 1, respectively, but these portions may be omitted. That is, the first external electrode 4 may be provided on at least the first end surface 1E, and the second external electrode 5 may be provided on at least the first end surface 1E.

In a multilayer ceramic electronic component according to an example embodiment of the present invention, it is preferable that the resin layer non-formation region of the first external electrode is spaced away from the first end surface on the first main surface, the second main surface, the first lateral surface, and the second lateral surface of the ceramic element body, and the resin layer non-formation region of the second external electrode is spaced away from the second end surface on the first main surface, the second main surface, the first lateral surface, and the second lateral surface of the ceramic element body. In such a configuration, the resin layer is wrapped between the base external electrodes and the plated external electrode layer, such that the integrity of the first external electrode and the second external electrode is improved, and the mechanical strength is improved.

It is also preferable that, when a dimension in the length direction of a portion of each of the first external electrode and the second external electrode provided on the first main surface, the second main surface, the first lateral surface, and the second lateral surface is defined as 100%, a ratio of a dimension in the length direction of a region where the resin layer covers the base external electrodes which are discontinuously provided and the exposed regions is, for example, about 75% or less. In such a configuration, it is possible to sufficiently ensure the dimension in the length direction of the resin layer non-formation region, and it is possible to increase the bonding strength between the base external electrodes and the plated external electrode layer, such that the mechanical strength of each of the first external electrode and the second external electrode is improved. In addition, since it is possible to sufficiently ensure the dimension in the length direction of the resin layer non-formation region, and it is possible to ensure the electrical connection between the base external electrodes and the plated external electrode layer, the electrical reliability of each of the first external electrode and the second external electrode is improved.

It is also preferable that the resin layer includes metal. In such a configuration, since the base external electrodes 6 and the plated external electrode layer are electrically connected via the resin layer 7, the electrical reliability of each of the first external electrode and the second external electrode is improved.

It is also preferable that, in a cross section parallel or substantially parallel to the first lateral surface and the second lateral surface, when a portion where a dimension in a height direction of the ceramic element body becomes largest is obtained, a first point on the first main surface, which is one starting point of the dimension, and a second point on the second main surface, which is one other starting point of the dimension, are obtained, and a first imaginary line passing through the first point extending in the length direction and a second imaginary line passing through the second point extending in the length direction are drawn, the first imaginary line neither overlaps with the resin layer of the first external electrode nor the resin layer of the second external electrode, and the second imaginary line neither overlaps with the resin layer of the first external electrode nor the resin layer of the second external electrode. In such a configuration, when the multilayer ceramic capacitor is mounted on a substrate or the like by, for example, reflow soldering or the like, an opposite surface that connects a plurality of protruding portions appearing on the surface of the plated external electrode layer and is opposed to the mounting surface (upper main surface) of the substrate enters a more parallel state relative to the mounting surface of the substrate. This makes it possible to provide stable mounting onto a substrate or the like, such that mounting defects such as, for example, the tombstone phenomenon are less likely to occur.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a ceramic element body including a plurality of first internal electrodes and a plurality of second internal electrodes laminated therein, a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction;
a first external electrode on the first end surface and including an edge portion extending from the first end surface toward each of the first main surface, the second main surface, the first lateral surface, and the second lateral surface; and
a second external electrode on the second end surface and including an edge portion extending from the second end surface toward each of the first main surface, the second main surface, the first lateral surface, and the second lateral surface; wherein
the plurality of first internal electrodes each extend toward and are exposed at the first end surface, and each is connected to the first external electrode;
the plurality of second internal electrodes each extend toward and are exposed at the second end surface, and each is connected to the second external electrode;
the first external electrode and the second external electrode each include base external electrodes, a resin layer provided outside the base external electrodes, and at least one plated external electrode layer provided outside the resin layer;
the base external electrodes are discontinuously provided on the ceramic element body;
the ceramic element body includes exposed regions partially exposed from the base external electrodes;
the resin layer covers the base external electrodes and the exposed regions;
in the first external electrode, the resin layer completely covers the base external electrodes and the exposed regions on the first end surface, and in the second external electrode, the resin layer completely covers the base external electrodes and the exposed regions on the second end surface; and
the first external electrode and the second external electrode each include, on the first main surface, the second main surface, the first lateral surface, and the second lateral surface, respectively, a region where the resin layer covers the base external electrodes and the exposed regions, and a resin layer non-formation region where the resin layer does not cover the base external electrodes or the exposed regions.

2. The multilayer ceramic electronic component according to claim 1, wherein
the resin layer non-formation region of the first external electrode is spaced away from the first end surface on the first main surface, the second main surface, the first lateral surface, and the second lateral surface of the ceramic element body; and
the resin layer non-formation region of the second external electrode is spaced away from the second end surface on the first main surface, the second main surface, the first lateral surface, and the second lateral surface of the ceramic element body.

3. The multilayer ceramic electronic component according to claim 1, wherein
a dimension in the length direction of a portion of each of the first external electrode and the second external electrode on the first main surface, the second main surface, the first lateral surface, and the second lateral surface is defined as 100%; and
a ratio of a dimension in the length direction of a region where the resin layer covers the base external electrodes which are discontinuously provided and the exposed regions is about 75% or less.

4. The multilayer ceramic electronic component according to claim 1, wherein the base external electrodes and the plated external electrode layer are connected to each other mechanically and electrically in the resin layer non-formation region.

5. The multilayer ceramic electronic component according to claim 1, wherein the resin layer includes metal.

6. The multilayer ceramic electronic component according to claim 1, wherein, in a cross section parallel or substantially parallel to the first lateral surface and the second lateral surface, when a portion where a dimension in a height direction of the ceramic element body becomes largest is obtained, a first point on the first main surface, which is one starting point of the dimension, and a second point on the second main surface, which is one other starting point of the dimension, are obtained, and assuming a first imaginary line passes through the first point extending in the length direction and a second imaginary line passes through the second point extending in the length direction, the first imaginary line neither overlaps with the resin layer of the first external electrode nor the resin layer of the second external electrode, and the second imaginary line neither overlaps with the resin layer of the first external electrode nor the resin layer of the second external electrode.

7. The multilayer ceramic electronic component according to claim 1, wherein the ceramic element body includes a plurality of dielectric layers interposed between the plurality of first and second internal electrodes.

8. The multilayer ceramic electronic component according to claim 7, wherein each of the plurality of ceramic layers includes BaTiO₃.

9. The multilayer ceramic electronic component according to claim 7, wherein a number of the plurality of ceramic layers is 10 to 2000 layers.

10. The multilayer ceramic electronic component according to claim 1, wherein each of the plurality of first and second internal electrodes includes at least one of Ni, Cu, Ag, Pd, Au, or an alloy thereof.

11. The multilayer ceramic electronic component according to claim 1, wherein a thickness of each of the plurality of first and second internal electrodes is about 0.1 μm to about 10.0 μm.

12. The multilayer ceramic electronic component according to claim 1, wherein a thickness of each of the first and second external electrodes is about 0.1 μm to about 20.0 μm.

13. The multilayer ceramic electronic component according to claim 1, wherein the at least one plated external electrode layer includes a first Ni plated electrode layer and a second Sn plated electrode layer.

14. The multilayer ceramic electronic component according to claim 1, wherein the base electrode layer includes metal and a glass component.

15. The multilayer ceramic electronic component according to claim 14, wherein the metal includes at least one of Cu, Ni, Ag, Pd, Au, or an alloy thereof.

16. The multilayer ceramic electronic component according to claim 14, wherein the glass component includes at least one of B, Si, Ba, Mg, Al, or Li.

17. The multilayer ceramic electronic component according to claim 1, wherein
a dimension of the first external electrodes in a middle of the first end surface is about 20 μm or less; and
a dimension of the second external electrodes in a middle of the second end surface is about 20 μm or less.

18. The multilayer ceramic electronic component according to claim 1, wherein an average dimension of the exposed regions in a cross section of the multilayer ceramic electronic component parallel or substantially parallel to the first and second lateral surfaces is about 0.1 μm or more and about 10.0 μm or less.
